(19) United States
(12) Patent Application Publication
(10) Pub. No.: US 2019/0196753 A1
(43) Pub. Date: Jun. 27, 2019

(54) INFORMATION PROCESSING APPARATUS, METHOD OF PROCESSING INFORMATION, AND STORAGE MEDIUM

(71) Applicant: Saori MINEGISHI, Kanagawa (JP)

(72) Inventor: Saori MINEGISHI, Kanagawa (JP)

(73) Assignee: Ricoh Company, Ltd., Tokyo (JP)

(21) Appl. No.: 16/207,384

(22) Filed: Dec. 3, 2018

(30) Foreign Application Priority Data
Dec. 27, 2017 (JP) 2017-250838

(51) Int. Cl. G06F 3/12

(52) U.S. Cl. CPC G06F 3/1205; G06F 3/1239; G06F 3/1258; G06F 3/1254; G06F 3/125

(57) ABSTRACT

An information processing apparatus includes circuitry configured to acquire document information associated with a document, determine recommended setting for printing and a reduction ratio of resource for printing based on the document information and a function of an execution device that prints image of the document on a medium, the reduction ratio of resource being calculated based on a ratio of an amount of the resource required for printing when the printing is performed based on the acquired document information and an amount of the resource required for printing when the printing is performed based on the recommended setting, and display recommended information including the recommended setting and the reduction ratio of the resource on a display.

### CROSS-REFERENCE TO RELATED APPLICATION

This application claims priority pursuant to 35 U.S.C. § 119(a) to Japanese Patent Application No. 2017-250838, filed on Dec. 27, 2017 in the Japan Patent Office, the disclosure of which is incorporated by reference herein in its entirety.

### BACKGROUND

### Technical Field

This disclosure relates to an information processing apparatus, a method of processing information, and a storage medium.

### Background Art

Image forming apparatuses that can automatically change print settings used for a printing operation are known. For example, a print system that can propose alternative condition settings that can reduce the number of printed sheets compared to normal condition settings set by a user is known.

### SUMMARY

In one aspect of the present invention, an information processing apparatus is devised. The information processing apparatus includes circuitry configured to acquire document information associated with a document, determine recommended setting for printing and a reduction ratio of resource for printing based on the document information and a function of an execution device that prints image of the document on a medium, the reduction ratio of resource being calculated based on a ratio of an amount of the resource required for printing when the printing is performed based on the acquired document information and an amount of the resource required for printing when the printing is performed based on the recommended setting, and display recommended information including the recommended setting and the reduction ratio of the resource on a display.

In another aspect of the present invention, a method of processing information is devised. The method includes acquiring document information associated with a document, determining, based on the document information and a function of an execution device that prints the document on a medium, recommended setting for printing and a reduction ratio of resource for printing by calculating a ratio of an amount of the resource required for printing when the printing is performed based on the acquired document information and an amount of the resource required for printing when the printing is performed based on the recommended setting, and displaying recommended information including the recommended setting and the reduction ratio of the resource on a display.

In another aspect of the present invention, a non-transitory computer readable storage medium storing one or more instructions that, when executed by one or more processors, cause the one or more processors to execute a method of processing information is devised. The method includes acquiring document information associated with a document, determining, based on the document information and a function of an execution device that prints the document on a medium, recommended setting for printing and a reduction ratio of resource for printing by calculating a ratio of an amount of the resource required for printing when the printing is performed based on the acquired document information and an amount of the resource required for printing when the printing is performed based on the recommended setting, and displaying recommended information including the recommended setting and the reduction ratio of the resource on a display.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIG. 1 illustrates an example of a hardware block diagram of a multifunction peripherals (MFP);

FIG. 2 illustrates an example of a functional block diagram of the MFP of FIG. 1;

FIG. 3 illustrates an example of a schematic view of a home screen;

FIG. 4 illustrates an example of a schematic view of an initial screen;

FIG. 5 illustrates an example of a schematic view of a color information selection screen;

FIG. 6 illustrates an example of a schematic view of a color change selection screen;

FIG. 7 illustrates an example of a schematic view of a document sheet amount selection screen;

FIG. 8 illustrates an example of a schematic view of a document face selection screen:

FIG. 9 illustrates an example of a schematic view of a document direction setting screen;

FIG. 10 illustrates an example of data configuration of recommended setting management information;

FIG. 11 illustrates an example of data configuration of resource reduction management information;

FIG. 12 illustrates an example of a schematic view of a recommended information screen;

FIG. 13 illustrates an example of a schematic view of another recommended information screen;

FIG. 14 illustrates an example of a graphical image indicating an effect of using recommended setting;

FIG. 15 illustrates an example of a schematic view of another recommended information screen; and

FIG. 16 is an example of a flowchart illustrating the steps of processing information;

The accompanying drawings are intended to depict embodiments of the present invention and should not be interpreted to limit the scope thereof. The accompanying drawings are not to be considered as drawn to scale unless explicitly noted.

### DETAILED DESCRIPTION

A description is now given of exemplary embodiments of the present inventions. It should be noted that although such terms as first, second, etc. may be used herein to describe various elements, components, regions, layers and/or units, it should be understood that such elements, components, regions, layers and/or units are not limited thereby because such terms are relative, that is, used only to distinguish one element, component, region, layer or unit from another region, layer or unit. Thus, for example, a first element, component, ration, layer or unit discussed below could be termed a second element, component, region, layer or unit without departing from the teachings of the present inventions.

In addition, it should be noted that the terminology used herein is for the purpose of describing particular embodiments only and is not intended to be limiting of the present inventions. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Hereinafter, a description is given of an information processing apparatus, an information processing method, and a storage medium of storing a program in detail with reference to the accompanying drawings.

Hereinafter, a description is given of the information processing apparatus, such as a multifunction peripherals (MFP), but the information processing apparatus is not limited thereto. The MFP is an apparatus having at least two mechanisms selectable from a printing mechanism, a copying mechanism, a scanner mechanism, and a facsimile mechanism. In this description, it is assumed that the MFP includes at least the copying mechanism.

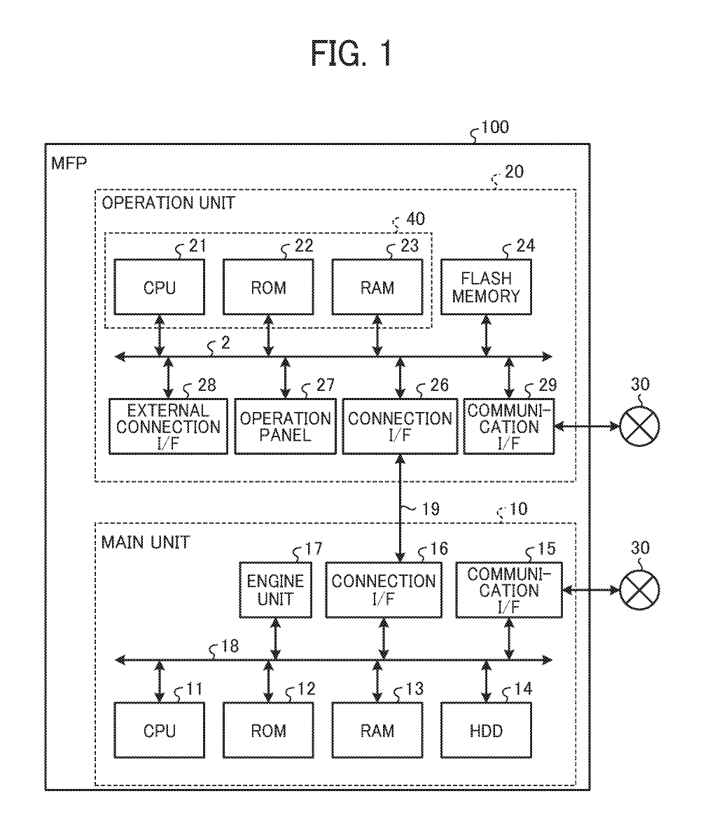

FIG. 1 illustrates an example of a hardware block diagram of MFP 100 of the embodiment.

The MFP 100 includes, for example, a main unit 10 and an operation unit 20.

The main unit 10 is a device that can implement various mechanisms such as a copying mechanism, a scanner mechanism, a facsimile mechanism, a printing mechanism, and the like. In the embodiment, the main unit 10 includes, for example, at least the copying mechanism. In this description, the main unit 10 is also referred to as the main device.

The operation unit 20 receives an input operation performed by a user and displays various types of screens as display screens. In this description, the operation unit 20 is also referred to as the operation device. The operation unit 20 is installed with a unique operating system (OS) to be described later. When the operation unit 20 receives the input operation performed by the user, the operation unit 20 receives, for example, an instruction for operation and/or information associated with the user operation.

The main unit 10 and the operation unit 20 are communicatively connected with each other through a communication channel 19. The communication channel 19 can use, for example, a universal serial bus (USB) standard, and can be any channel standard such as wired communication standard and/or wireless communication standard. Further, the communication channel 19 can be a network such as the Internet, a telephone line, or the like.

Further, the main unit 10 can perform various operations in accordance with the inputs received at the operation unit 20. Further, the main unit 10 can communicate with an external device and can perform operations in accordance with instructions received from the external device.

Hereinafter, a description is given of a hardware configuration of the main unit 10. As illustrated in FIG. 1, the main unit 10 includes, for example, a central processing unit (CPU) 11, a read only memory (ROM) 12, a random access memory (RAM) 13, a hard disk drive (HDD) 14, a communication interface (I/F) 15, a connection interface (I/F) 16, and an engine unit 17 connected with each other via a system bus 18.

The CPU 11 controls operations of the main unit 10 in a coordinated manner. By executing one or more programs (hereinafter, program) stored in the ROM 12 and/or HDD 14 at the RAM 13 used as a work area, the CPU 11 controls the operations of the main unit 10 entirely and implements various mechanisms such as the copying mechanism, scanner mechanism, facsimile mechanism, printing mechanism, and the like described above.

The communication I/F 15 is an interface for connecting with a network 30. The connection I/F 16 is an interface for communicating with the operation unit 20 via the communication channel 19.

The engine unit 17 includes one or more hardware units that perform various processing for implementing various mechanisms, such as the copying mechanism, scanner mechanism, facsimile mechanism, printing mechanism, and the like, which are other than general-purpose information processing and communication processing, For example, the engine unit 17 includes, for example, a scanner for scanning an image of document, a plotter for printing an image from scanned image data and/or image data acquired from an external apparatus, and a facsimile machine for performing a facsimile communication. Further, a finisher for sorting printed media such as sheets, and an automatic document feeder (ADF) for automatically feeding document sheets can be provided as options.

In this description, the engine unit 17 is an example of an execution device or unit, and the engine unit 17 includes, for example, at least the copying mechanism. Specifically, the copying mechanism is a mechanism for copying or printing document image on a medium or media, such as sheet. Hereinafter, the medium or media indicate one or more media used for copying or printing.

The medium is image formable materials, such as paper, resin sheet, or the like. In the embodiment, the medium may be referred to sheet (e.g., paper) as an example of the medium. Therefore, in this description, the medium may be simply referred to as “sheet” or “paper.” Hereinafter, the medium or media indicate one or more media used for copying or printing, and the terms of medium and media are interchangeably used in this description.

The document is a sheet medium (e.g., paper) to be copied. That is, in the embodiment, the document means a medium to be copied, but does not mean electronic data. Specifically, the document means a document sheet. The document to be copied may be also referred to as the original document.

In the embodiment, the engine unit 17 has one or more functions related to the copying mechanism. The function of the engine unit 17 means, for example, a function related to a method of printing document image on a medium or media.

Specifically, the function of the engine unit 17 includes at least one of a duplex printing function, an aggregation function, and a bookbinding function.

The duplex printing function is a function of printing a document image of document face on two faces (both faces) of a print medium, such as sheet. The document face of the document indicates a face to be copied on the print medium.

The aggregation function is a function of aggregating and printing a plurality of document faces on each print medium. The aggregation function includes, for example, a function of aggregating and printing a plurality number of document faces on one print medium (e.g., sheet) in accordance with an aggregation number of document faces of the document.

The bookbinding printing function is a function of sorting and printing the document faces of the document to create a two-folded book. Specifically, the bookbinding printing function is a function of arranging a plurality of document faces of the document on two faces of each print medium (e.g., sheet), printing the plurality of document faces on two faces of each print medium (e.g., sheet) while adjusting the arrangement order of the document faces printed on each print medium (e.g., sheet) so that document faces can be visually recognized in accordance with the reading order of the document faces of the document when the bookbinding is completed.

The bookbinding printing function can further include a plurality of functions. For example, the bookbinding printing function can include functions such as a mini-book printing function, a weekly magazine printing function, and the like. When the mini printing function is used, a plurality of document faces of the document is scanned, two document faces are aggregated and printed on one face of paper and another two document faces are aggregated and printed on another face of the same paper, and then a plurality of the printed paper is folded and then stacked so that the document faces printed on the paper can be visually recognized in accordance with the reading order of the document faces of the document. Further, when the weekly magazine printing function is used, a plurality of read document faces is scanned, two document faces are aggregated and printed on one face of paper and another two document faces are aggregated and printed on another face of the same paper, and then a plurality of printed paper is stacked and then folded so that the document faces printed on paper can be visually recognized in accordance with the reading order of the document faces.

Further, the bookbinding printing function can be combined with the aggregation function as an aggregate bookbinding printing function. The aggregate bookbinding printing function is a function of aggregating and printing a plurality of document faces for each printing page to be printed as a book.

In the embodiment, the engine unit 17 includes, for example, the weekly magazine printing function, and the aggregate bookbinding printing function as the bookbinding printing function.

Hereinafter, a description is given of an example of a hardware configuration of the operation unit 20. As illustrated in FIG. 1, the operation unit 20 includes, for example, a CPU 21, a ROM 22, a RAM 23, a flash memory 24, a communication I/F 29, a connection I/F 26, an operation panel 27, and an external connection I/F 28 connected with each other via a system bus 2.

The CPU 21 controls operations of the operation unit 20 in a coordinated manner. By executing one or more programs (hereinafter, program) stored in the ROM 22 and/or the flash memory 24 on the RAM 23 used as a work area, the CPU 21 controls operations of the operation unit 20 entirely and implements various functions, such as displaying of information (e.g., text, image) in accordance with an input received from a user.

The communication I/F 29 is an interface for connecting with the network 30. The connection I/F 26 is an interface for communicating with the main unit 10 via the communication channel 19. The external connection IT 28 is an interface connected to an external device, such as an integrated circuit (IC) card reader or the like.

The operation panel 27 is an example of a display. The operation panel 27 receives various inputs in accordance with a user operation and displays various information. For example, the operation panel 27 displays information corresponding to an input received from the user, various screens, and the like.

In the embodiment, the operation panel 27 is configured with a liquid crystal display (LCD) mounted with a touch panel function, but not limited thereto. For example, the operation panel 27 can be configured with an organic electro-luminescence (OEL) display device mounted with a touch panel mechanism. In addition to or alternatively, an operation unit such as a hardware key and a display mechanism such as a lamp can be provided.

In the embodiment, software installed on the main unit 10 and software installed on the operation unit 20 differ each other to maintain independence of the main unit 10 and the operation unit 20. That is, the main unit 10 and the operation unit 20 operate independently each other using different operating systems. For example, Linux (registered trademark) may be used as the software of the main unit 10 while Android (registered trademark) may be used as the software of the operation unit 20.

In the MFP 100 of the embodiment, since the main unit 10 and the operation unit 20 operate using different operating systems, communication between the main unit 10 and the operation unit 20 is performed as communication between different apparatuses or devices rather than an internal communication processing in a single apparatus. The communication between the main unit 10 and the operation unit 20 includes, for example, transmitting a command instruction contents, input by a user and received by the operation unit 20, to the main unit 10, and transmitting an event from the main unit 10 to the operation unit 20.

For example, when the operation unit 20 transmits a command as the communication to the main unit 10, the operation unit 20 can use the mechanism of the main unit 10. Further, the event transmitted from the main unit 10 to the operation unit 20 includes, for example, an execution status of an operation performed at the main unit 10, contents set at the main unit 10, and the like.

In the embodiment, the MFP 100 includes the main unit 10 and the operation unit 20 in one apparatus, but not limited thereto. For example, the main unit 10 and the operation unit 20 can be separated into a plurality of apparatuses. That is, the main unit 10 and the operation unit 20 can be configured as different apparatuses, such as a main device and a tablet terminal device.

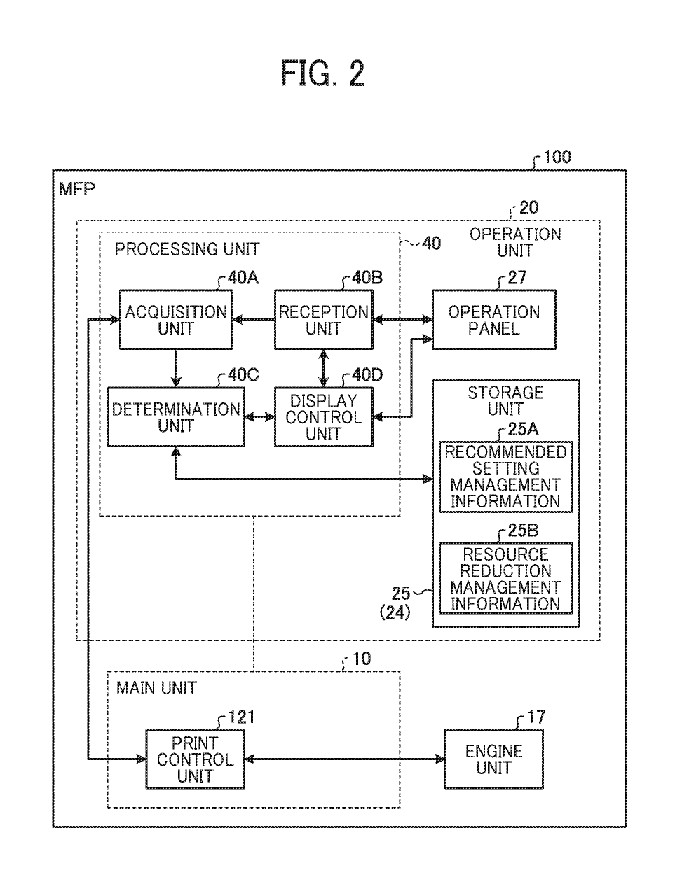

Hereinafter, a description is given of a functional configuration of the MFP 100. FIG. 2 illustrates an example of a functional block diagram of the MFP 100.

As illustrated in FIG. 2, the main unit 10 of the MFP 100 includes, for example, a print control unit 121. The print control unit 121 controls the main unit 10 entirely. The print control unit 121 can be implemented by the CPU 11, the ROM 12, and the RAM 13.

The print control unit 121 is installed with one or more application software programs in advance for providing various functions by operating hardware resources. In the following description, the application software programs may be simply referred to as an “application.” The application includes, for example, a copy application for providing the copying mechanism, a scanner application for providing the scanner mechanism, a facsimile application for providing the facsimile mechanism, a printer application for providing the printing mechanism, and the like.

In the embodiment, the print control unit 121 controls the engine unit 17 in accordance with execution instruction information received from the operation unit 20. Further, when the print control unit 121 receives a request for inquiring the function of the engine unit 17 from the operation unit 20, the print control unit 121 notifies the function information indicating the function of the engine unit 17 to the operation unit 20.

As illustrated in FIG. 2, the operation unit 20 of the MFP 100 includes, for example, a processing unit 40, an operation panel 27, and a storage unit 25. The processing unit 40, the operation panel 27, and the storage unit 25 connected with each other to communicate data and signals with each other.

The storage unit 25 stores various data. The storage unit 25 can be implemented, for example, by a magnetic, optical or electrically storable storage device such as an HDD, a solid state drive (SSD), a memory card, an optical disk, a RAM, a ROM, and the like. Specifically, the storage unit 25 is implemented by, for example, the flash memory 24 and/or the ROM 22 (FIG. 1).

In the embodiment, the storage unit 25 stores, for example, recommended setting management information 25A and resource reduction management information 25B in advance as illustrated in FIG. 2. The details of the recommended setting management information 25A and the resource reduction management information 25B will be described later.

The processing unit 40 controls the operation unit 20. The processing unit 40 can be implemented by the CPU 21, the ROM 22, and the RAM 23 (see FIG. I).

The processing unit 40 includes, for example, an acquisition unit 40A, a reception unit 40B, a determination unit 40C, and a display control unit 40D as illustrated in FIG. 2.

The acquisition unit 40A, the reception unit 40B, the determination unit 40C, and the display control unit 40D can be implemented by one or more processors or circuitry. For example, each of the above described units can be implemented by executing one or more software programs using one or more processors, such as the CPU 21. Further, each of the above described units can be implemented by a processor, such as dedicated integrated circuit (IC) that is a hardware resource. Further, each of the above described units can be implemented in combination with software and hardware. When a plurality of processors is used, each processor may implement one of the units or two or more units,

The acquisition unit 40A acquires document information associated with document to be copied (target document). The document information is information indicating a state of the target document to be copied. Specifically, the document information includes, for example, document sheet number information indicating the number of document sheets to be copied, document face information indicating whether the document face of the document to be printed is one-face document or two-face document. The one-face document means that the target document to be printed has an image on one face of each document sheet alone while the two-face document means that the target document to be printed has an image on both faces (two faces, front and rear faces) of each document sheet.

Further, the document information can further include other information. For example, the document information can further include at least one of color information of document face of document, color change information of document face of document, and document direction or orientation information of document.

The color information indicates whether text and/or image on the document face of the document is color image or monochrome image (e.g., black and white). The color change information is information indicating whether allowing to change a color used for printing the document face of document. The document direction or orientation information is information indicating the direction or orientation of the document that is placed on a document placement portion at the main unit 10.

In the embodiment, the acquisition unit 40A acquires the document information from the operation panel 27 via the reception unit 40B. The reception unit 40B receives an input when a user performs an operation on the operation panel 27. By operating the operation panel 27, the user can input the document information. The reception unit 40B receives the document information from the operation panel 27 and outputs the document information to the acquisition unit 40A. With this processing, the acquisition unit 40A acquires the document information.

Further, the acquisition unit 404 acquires the function information from the print control unit 121 of the main unit 10. The acquisition unit 40A transmits an inquiry request of the function of the engine unit 17 to the print control unit 121. The print control unit 121, which receives the inquiry request, notifies the function information indicating the function of the engine unit 17 to the processing unit 40. Then, the acquisition unit 40A of the processing unit 40 acquires the function information from the print control unit 121.

In the embodiment, the function information indicating the function of the engine unit 17 includes, for example, at least one of functions such as a duplex printing function, an aggregation function, and a bookbinding printing function.

The display control unit 40D controls displaying of various information and various screens on the operation panel 27.

In the embodiment, the display control unit 40D controls displaying of various screens, such as a home screen, a reception screen, and a recommended information screen displayable on the operation panel 27.

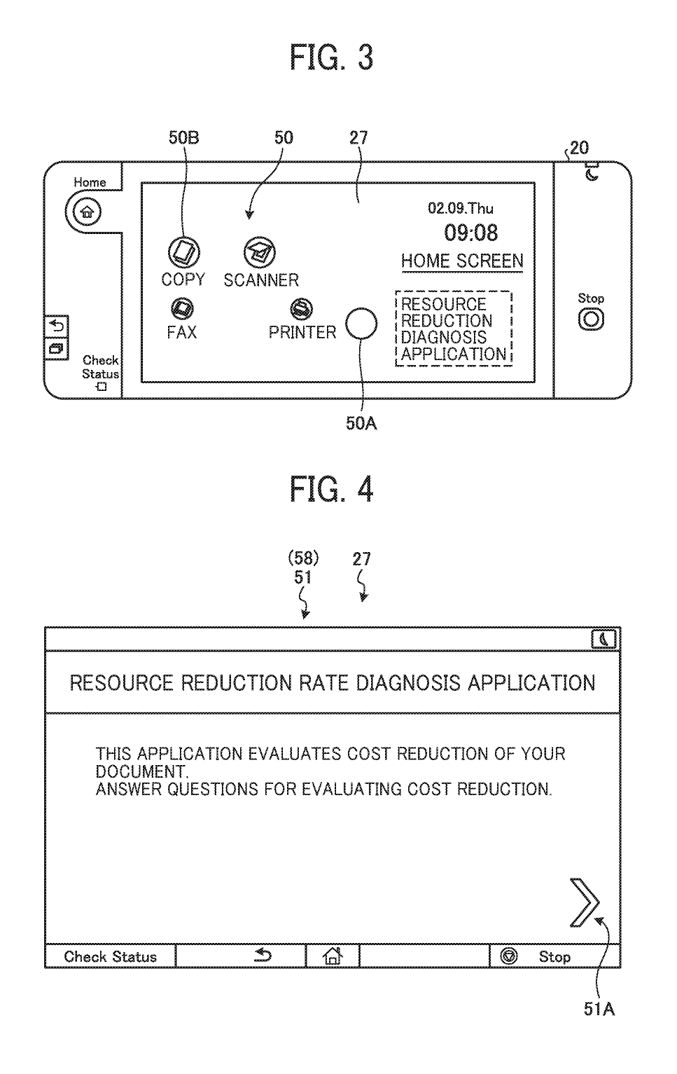

The home screen is a basic screen that is firstly displayed after the power supply to the MFP 100 is turned on. FIG. 3 illustrates an example of a schematic view of a home screen 50. The home screen 50 displays, for example, a plurality of icons (e.g., button images) associated with a plurality of types of applications with one-to-one relationship.

For example, the home screen 50 displays the icons respectively associated with the copy application, the scanner application, the facsimile application, and the printer application.

In the embodiment, the processing unit 40 is installed with a resource reduction diagnosis application. The resource reduction diagnosis application is an application for proposing recommended setting, and assessing, estimating or diagnosing an effect of the recommended setting when copying of document is performed based on the recommended setting. The effect of using the recommended setting includes, for example, resource reduction effect, such as sheet reduction effect indicating a sheet reduction ratio when the recommended setting is used, colorant reduction effect indicating a reduction ratio of the number of used colorants when the recommended setting is used, print-fee reduction effect indicating a print-fee reduction ratio when the recommended setting is used. The program for implementing the resource reduction diagnosis application is an example of an information processing program.

The home screen 50 includes, for example, an icon 50, or instructing an execution of the resource reduction diagnosis application.

The display control unit 40D controls the operation panel 27 to display the home screen 50. A user refers to the home screen 50 displayed on the operation panel 27 and operates the icon 50A to instruct an execution of the resource reduction diagnosis application. Then, the reception unit 40B receives the execution instruction of the resource reduction diagnosis application and the processing unit 40 executes the information processing program of the embodiment. Further, the processing unit 40 can he configured to execute the information processing program of the embodiment when an icon 50B associated with the copy application in the home screen 50 is operated.

When the display control unit 40D receives the execution instruction of the resource reduction diagnosis application via the reception unit 40B, the display control unit 40D controls the operation panel 27 to display a reception screen. The reception screen is a display screen used for receiving an input of document information.

FIGS. 4 to 9 illustrate examples of schematic views of a reception screen 58.

FIG. 4 illustrates an example of a schematic view of an initial screen 51. Hereinafter, the initial screen 51 is described as one example of the reception screen 58. The initial screen 51 is a screen that is displayed at first when the resource reduction diagnosis application is activated for executing the diagnosis of resource reduction. The initial screen 51 includes, for example, an icon 51A for instructing the execution of the resource reduction diagnosis application. When a user operates the icon 51A on the operation panel 27 (FIG. 4), the reception unit 40B receives command information indicating the execution instruction of the resource reduction diagnosis application and outputs the command information to the display control unit 40D.

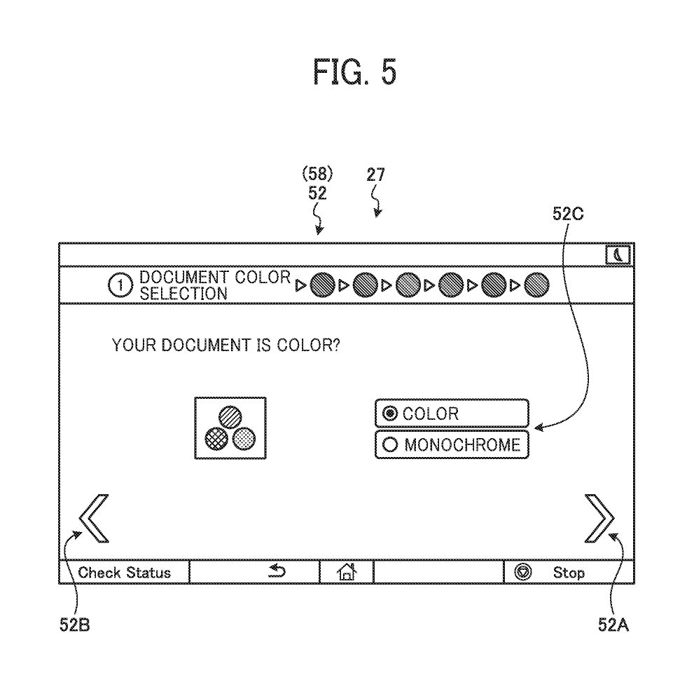

When the display control unit 40D receives the command information indicating the execution instruction of the resource reduction diagnosis application, the display control unit 40D displays a color information selection screen on the operation panel 27 as illustrated in FIG. 5.

FIG. 5 illustrates an example of a schematic view of a color information selection screen 52. Hereinafter, the color information selection screen 52 is described as one example of the reception screen 58. The color information selection screen 52 is used as the reception screen 58 for receiving the color information of a document face of a document to be copied. The color information selection screen 52 includes, for example, an icon 52C for receiving a selection of “color” or a selection of “monochrome,” an icon 52A for receiving an execution instruction, and an icon 52B for receiving an instruction to return to the previous screen.

A user operates the icon 52C on the operation panel 27 to input color information. Specifically, the user operates the icon 52C associated with color information of the document face of the document to be copied to input the color information.

FIG. 5 illustrates an example case that information indicating “color” is input by selecting “color” in the icon 52C. In response to a user operation of the icon 52A, the reception unit 40B receives the input color information and outputs the color information to the acquisition unit 40A and the display control unit 40D. Further, if the user operates the icon 52B to instruct a return to the previous screen, the display control unit 40D displays the reception screen 58 that was previously displayed on the operation panel 27.

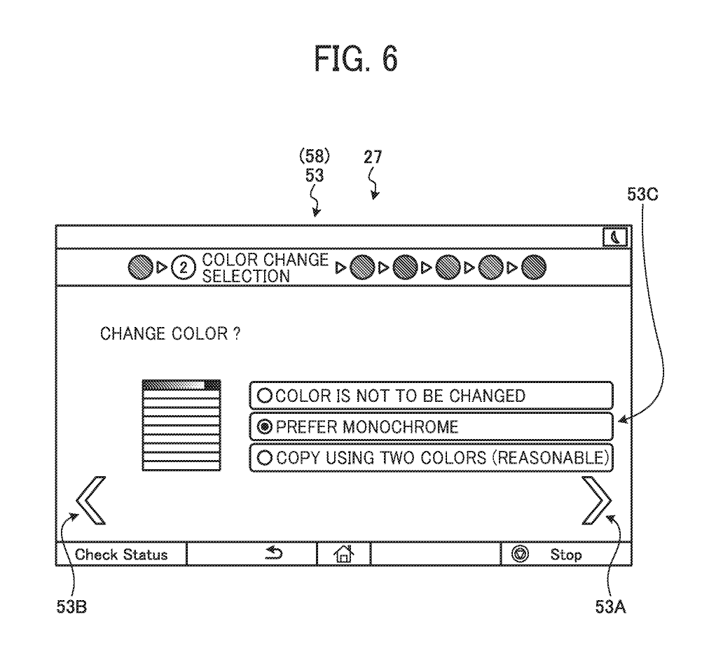

When the display control unit 40D receives the input color information, the display control unit 40D displays a color change selection screen on the operation panel 27 as illustrated in FIG. 6.

FIG. 6 illustrates an example of a schematic view of a color change selection screen 53. Hereinafter, the color change selection screen 53 is described as one example of the reception screen 58. The color change selection screen 53 is used as the reception screen 58 for receiving the color change information. The color change selection screen 53 includes, for example, an icon 53C for receiving a selection of “color is not to be changed,” a selection of “monochrome” or a selection of “copy using two colors (reasonable),” an icon 53A for receiving an execution instruction, and an icon 53B for receiving an instruction to return to the previous screen.

When a user operates the operation panel 27, the user operates the icon 53C in accordance with a request for changing color used for printing a document face of a document to be copied.

FIG. 6 illustrates an example case that color change information used for printing the document face of the document is changed to “monochrome” by selecting “monochrome.” In response to a user selection operation of the icon 53A, the reception unit 40B receives the color change information indicating either the color is not to be changed, the color is changed to the monochrome, or the color for copying is changed to two colors, and outputs the selected color change information to the acquisition unit 40A and the display control unit 40D. Further, if the user operates the icon 53B to instruct a return to the previous screen, the display control unit 40D displays the reception screen 58 that was previously displayed on the operation panel 27.

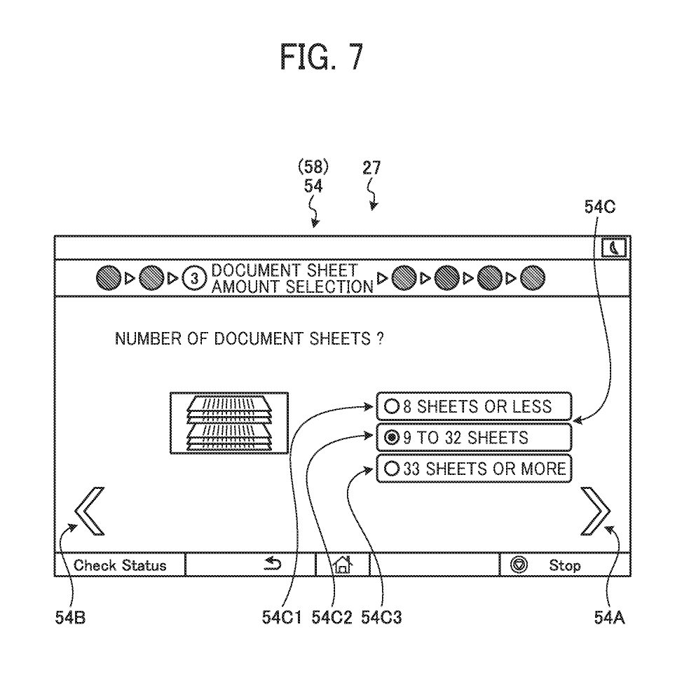

When the display control unit 40D receives the input color change information, the display control unit 401D displays a document sheet amount selection screen on the operation panel 27 as illustrated in FIG. 7.

FIG. 7 illustrates an example of a schematic view of a document sheet amount selection screen 54. Hereinafter, the document sheet amount selection screen 54 is described as one example of the reception screen 58. The document sheet amount selection screen 54 is used as the reception screen 58 for receiving the document sheet number information indicating the number of sheets of the document to be copied. The document sheet amount selection screen 54 includes, for example, a selection area. 54C, an icon 54A for receiving an execution instruction, and an icon 54B for receiving an instruction to return to the previous screen.

The selection area 54C is a field for selecting the number of document sheets of document to be copied (document sheet number information). In the embodiment, the document sheet amount selection screen 54 includes the selection area 54C for selecting the number of document sheets of document to be copied (document sheet number information). The selection area 54C includes, for example, a plurality of selectable options, such as a selection column 54C1, a selection column 54C2, a selection column 54C3, which differ in a sheet number range. The sheet number range can be set in accordance with the number of sheets suitable for the bookbinding printing. The sheet number range can be a pre-set range defining one or more ranges of sheet numbers.

In the embodiment, the selection area 54C includes, for example, the selection column 54C2 for selecting a given sheet number range suitable for the bookbinding printing, the selection column 54C1 for selecting another sheet number range less than the given sheet number range, and the selection column 54C3 for selecting another sheet number range greater than the given sheet number range.

FIG. 7 illustrates one example that the given sheet number range suitable for the bookbinding printing is set “9 to 32 sheets,” another sheet number range less than the given sheet number range is set “8 sheets or less,” and another sheet number range greater than the given sheet number range is set “33 sheets or more.” It should be noted that the upper and lower values of the given sheet number range are merely examples, but not limited thereto indicated in FIG. 7. Further, the sheets number range can be set in two steps, four steps, and other steps.

The display control unit 40D displays the selection area 54C indicating the given sheet number range suitable for the bookbinding printing on the operation panel 27, with which a user is not required to enter the number of sheets in consideration of the bookbinding printing. As a result, the input operation of document sheet number information can be simplified.

Further, the document sheet amount selection screen 54 can include an input field for directly inputting the document sheet number information indicating the number of sheets of document to be copied.

When a user operates the operation panel 27, the user selects the any one of the selection column 54C1, the selection column 54C2, and the selection column 54C3, each being associated with the sheet number range of document to be copied. FIG. 7 illustrates an example case that the given sheet number range of “9 to 32 sheets” suitable for the bookbinding printing is selected.

Then, if the user operates the icon 54A, the reception unit 40B receives the input of the document sheet number information and outputs the document sheet number information to the acquisition unit 40A and the display control unit 40D, in the embodiment, the acquisition unit 40A acquires the document sheet number information indicating the sheet number range input via the selection area 54C.

Further, if the user operates the icon 54B to instruct a return to the previous screen, the display control unit 40D displays the reception screen 58 that was previously displayed on the operation panel 27.

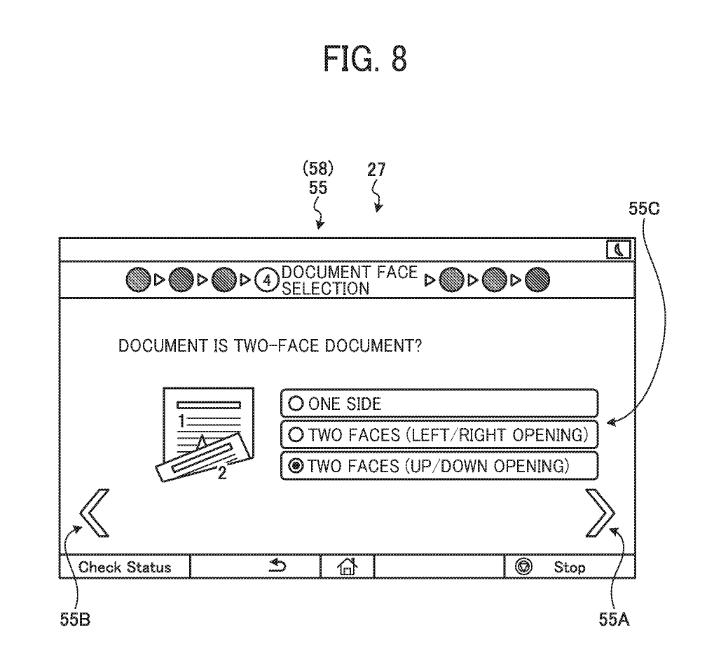

When the display control unit 40D receives the input document sheet number information, the display control unit 40D displays the document face selection screen on the operation panel 27 as illustrated in FIG. 8.

FIG. 8 illustrates an example of a schematic view of a document face selection screen 55. Hereinafter, the document face selection screen 55 is described as one example of the reception screen 58. The document face selection screen 55 is used as the reception screen 58 for receiving the document face information indicating whether a document face of a target document is one-face document or two-face document. The document face selection screen 55 includes, for example, an icon 55C, an icon 55A for receiving an execution instruction, and an icon 55B for receiving an instruction to return to the previous screen.

The icon 55C is an icon image for selecting the document face information. In the embodiment, the icon 55C is an icon image for selecting any one of “one face, two faces (left/right opening), and two faces (up/down opening). The “two faces (left/right opening)” means that the document face of the document to be copied is two faces, and the arrangement of the document faces in the document is “left and right opening.” The “left/right opening” means that the top and bottom of the front and back faces of the document are set in the same direction. Further, the “two faces (up/down opening)” means that the document face of the document to be copied is two faces, and the arrangement of the document faces in the document is “up and down.” The “up/down opening” means that the top and bottom of the front and back faces of the document are set in the opposite directions.

When a user operates the icon 55C on the operation panel 27, the document face information is input. FIG. 8 illustrates an example case when “two faces (up/down opening)” is input.

Then, if the user operates the icon 55A, the reception unit 40B receives the input document face information and outputs the document face information to the acquisition unit 40A and the display control unit 40D. Further, if the user operates the icon 55B to instruct a return to the previous screen, the display control unit 40D displays the reception screen 58 that was previously displayed on the operation panel 27.

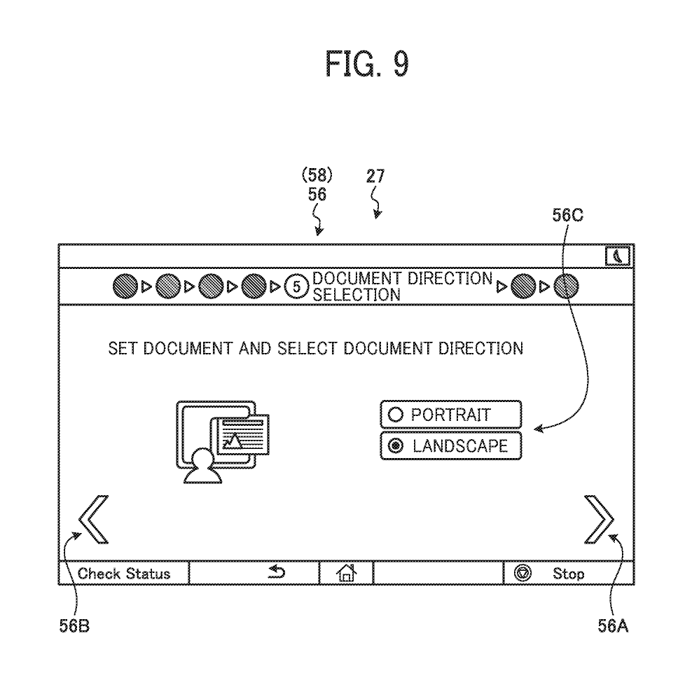

When the display control unit 40D receives the input document face information, the display control unit 40D displays a document direction setting screen on the operation panel 27 as illustrated in FIG. 9.

FIG. 9 illustrates an example of a schematic view of a document direction setting screen 56. Hereinafter, the document direction setting screen 56 is described as one example of the reception screen 58. The document direction setting screen 56 is used as the reception screen 58 for receiving the document direction information indicating a direction or orientation of the document to be placed on the document placement portion of the main unit 10. The document direction setting screen 56 includes, for example, an icon 56C, an icon 56A for receiving an execution instruction, and an icon 56B for receiving an instruction to return to the previous screen.

The icon 56C is an icon image for selecting the document direction or orientation of the document to be placed on the document placement portion of the main unit 10. In the embodiment, the icon 56C is an icon image for selecting “portrait” or “landscape” as the document direction or orientation of the document to be placed on the document placement portion of the main unit 10.

When a user operates the icon 56C on the operation panel 27, the document direction information is input. FIG. 9 illustrates an example case when the document direction of “landscape” is input as the document direction or orientation of the document.

Then, if the user operates the icon 56A, the reception unit 40B receives the input document direction information and outputs the document direction information to the acquisition unit 40A and the display control unit 40D. Further, if the user operates the icon 56B to instruct a return to the previous screen, the display control unit 40D displays the reception screen 58 that was previously displayed on the operation panel

As described above, when the display control unit 40D displays the reception screen 58 on the operation panel 27 and the reception unit 40B receives the document information input by the user, the reception unit 40B receives the document information. Then, the acquisition unit 40A acquires the document information from the reception unit 40B. In the embodiment, the acquisition unit 40A acquires, for example, the document information including the document sheet number information, document face information, color information, color change information, and document direction information. Further, the acquisition unit 40A may need to acquire the document information including at least the document sheet number information and the document face information, and further, the information included in the document information acquired by the acquisition unit 40A is not limited to the above information.

Referring back to FIG. 2, the description is continued. Hereinafter, a description is given of the determination unit 40C. Based on the document information acquired by the acquisition unit 40A and the function of the engine unit 17, the determination unit 40C computes and determines recommended setting for copying and the reduction ratio of used amount of sheet for copying (i.e., a sheet reduction ratio when the document is copied based on the recommended setting).

As disclosed in this description, based on the document information and the function of the engine unit 17 (execution unit or device) that prints the document on a medium or media, the determination unit 40C computes and determines recommended setting for printing and a reduction ratio of resource for printing by calculating a ratio of an amount of the resource required for printing when the printing is performed based on settings (e.g., initial settings) included in the acquired document information and an amount of the resource required for printing when the printing is performed based on the recommended setting. When the resource is, for example, the number of sheets required for printing, the reduction ratio of resource is calculated as a sheet reduction ratio, but the resource required for printing is not limited thereto. For example, when the resource is a print fee required for printing, the determination unit 40C computes and determines a print-fee reduction ratio to be described later. Further, the resource can be a printing time duration required for printing. The resource is not limited to examples described in this specification

In this description, the recommended setting includes one or more settings. For example, the recommended setting indicates one or more conditions settable for copying that is recommended by the processing unit 40 in view of the function of the engine unit 17, such as the duplex printing function, aggregation function, bookbinding printing function. Specifically, the recommended setting includes, for example, any one of the functions of the engine unit 17 (e.g., duplex printing function, aggregation function, bookbinding printing function) and the aggregation number. That is, the recommended setting is information indicating which function of the engine unit 17 is selected from a plurality of functions of the engine unit 17, and which aggregation number are used when a document is to be copied on media.

The reduction ratio of to-be-used sheet amount is calculated by dividing expected sheet amount used for copying a document on media based on the recommended setting (second expected sheet amount) with another expected sheet amount used for copying the same document on media based on the initial settings associated to the same document (first expected sheet amount). Hereinafter, the reduction ratio of to-be-used sheet amount may be referred to as the “sheet reduction ratio.” For example, the sheet reduction ratio can be calculated variously as below.

sheet reduction ratio=second expected sheet amount (recommended setting)/first expected sheet amount (initial setting)

sheet reduction ratio[first expected sheet amount (initial setting)−second expected sheet amount (recommended setting)]/first expected sheet amount (initial setting)

For example, the determination unit 40C computes and determines the recommended setting having the sheet reduction ratio that is equal to or greater than a first threshold based on the document information and the function of the engine unit 17 acquired by the acquisition unit 40A. The first threshold can be set in advance. The first threshold is, for example, 50%, 60%, 75%, and so forth, but not limited thereto. Further, the determination unit 40C can compute and determine the recommended setting having the highest sheet reduction ratio, in which the least number of sheets are used for copying. Further, the determination unit 40C can appropriately change the first threshold in accordance with an instruction of a user performed on the operation panel 27. Further, the determination unit 40C can compute and determine a number of recommended settings, which are arranged in an order from one recommended setting that can achieve the highest sheet reduction ratio.

Further, based on the document information and the function of the engine unit 17, the determination unit 40C can compute and determine the recommended setting that can satisfy one or more conditions. For example, the determination unit 40C can compute and determine the recommended setting that can satisfy any one of a first condition that the sheet reduction ratio is equal to or greater than the first threshold as above described, a second condition that the number of color materials used in the engine unit 17 for copying is a second threshold or less, a third condition that a level of easiness of reading of the printed sheet is equal to or greater than a third threshold, a combination of any two of the first, second and third conditions, and a combination of the first, second and third conditions.

The number of color materials indicates the number of types of color materials used in the engine unit 17, in the embodiment, the number of types of color materials is simply referred to as the number of color materials. When the engine unit 17 is an electrophotographic image forming unit, the color material is toner while when the engine unit 17 is an inkjet image forming unit, the color material is ink. As the number of color materials used for copying is smaller and the color material is not a special color, the type of used color materials and cost of used color materials can be reduced. The determination unit 40C can determine the second threshold set for the number of color materials in advance based on these considerations. Further, the second threshold can be changed as appropriate in accordance with an instruction of a user performed on the operation panel 27. Further, an amount or volume of color materials used in the engine unit 17 can be also calculated and determined by the determination unit 40C based on the document information and the function of the engine unit 17.

The level of easiness of reading of the printed sheet becomes higher values as images and characters formed on media (e.g., printed sheets) is more easily visible or readable for the user, and the higher the sharpness of images and characters. The determination unit 40C prepares a calculation formula for calculating the level of easiness of reading of the printed sheet in advance. Further, the sharpness of images and characters formed on the printed sheet can be calculated by using known methods. For example, a combination of the function of the engine unit 17 and the aggregation number is prepared as a plurality of patterns by selecting the function of the engine unit 17 and the aggregation number, and then the determination unit 40C calculates the level of easiness of reading of the printed sheet when copying a document to sheets using each of various patterns of combining the function of the engine unit 17 and the aggregation number. Then, the determination unit 40C can compute and determine the recommended setting that can achieve the third threshold or more for the level of easiness of reading of the printed sheet. The third threshold can be determined in advance. Further, the third threshold can be changed as appropriate in accordance with an instruction of a user performed on the operation panel 27

In the embodiment, the determination unit 40C stores the recommended setting management information 25A and the resource reduction management information 25B in the storage unit 25 in advance. Then, the determination unit 40C uses the recommended setting management information 25A and the resource reduction management information 25B to compute and determine the recommended setting and the reduction ratio of resource, such as the sheet reduction ratio.

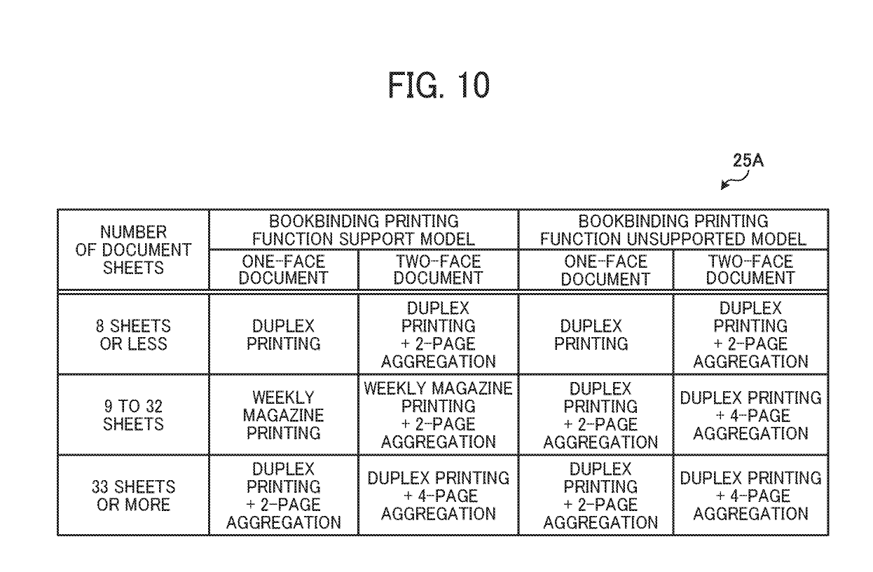

FIG. 10 illustrates an example of data configuration of the recommended setting management information 25A. The recommended setting management information 25A specifies one or more recommended settings for the document face information and the document sheet number information in view of each function of the engine unit 17.

The function of the engine unit 17 includes at least one of the duplex printing function, the aggregation function, and the bookbinding function as described above. FIG. 10 illustrates an example case of a “bookbinding printing function support model” and a “bookbinding printing function unsupported model.” The bookbinding printing function support model indicates that the engine unit 17 has the duplex printing function, the aggregation function, and the bookbinding function. The bookbinding printing function unsupported model indicates that the engine unit 17 has the duplex printing function and the aggregation function but does not have the bookbinding printing function.

In the embodiment, it is assumed that one recommended setting is registered in the recommended setting management information 25A for each of a plurality of combinations of the document face information and the document sheet number information in accordance with whether the engine unit 17 has the bookbinding printing function, in which the document face information includes one-face document and two-face document while the document sheet number information includes a plurality of sheet number ranges

Further, the recommended setting management information 25A can register a plurality of recommended settings for a plurality of combinations of the document face information (one-face document, two-face document) and the document sheet number information (sheet number ranges) in accordance with whether the engine unit 17 has the bookbinding printing function in advance. Further, the recommended setting management information 25A can register one or more recommended settings for a plurality of combinations of the functions included in the engine unit 17, the document face information, and the document sheet number information in advance.

In FIG. 10, “weekly magazine printing+2-page aggregation” means an aggregate bookbinding printing function having an aggregation number of “2.” Further, in FIG. 10, “duplex printing+2-page aggregation” indicates the duplex printing function having an aggregation number of “2.” Further, in FIG. 10, “duplex printing+4-page aggregation” indicates the duplex printing function having an aggregation number of “4.” Further, in FIG. 10, “duplex printing” indicates the duplex printing function having an aggregation number of “1” (no aggregation).

It should be noted that the recommended settings in FIG. 10 are examples, and the recommended settings corresponding to the function of the engine unit 17, the document face information, and the document sheet number information is not limited to the settings of FIG. 10.

In the embodiment, the determination unit 40C computes and determines the recommended setting by reading the recommended setting, corresponding to the function of the engine unit 17 indicated by the function information acquired by the acquisition unit 40A, the document sheet number information included in the document information acquired by the acquisition unit 40A, and the document face information included in the document information acquired by the acquisition unit 40A, from the recommended setting management information 25A.

Further, based on the document information and the function of the engine unit 17, the determination unit 40C can specify a calculation formula for calculating the recommended setting that satisfies at least any one of the first condition that the sheet reduction ratio is equal to or greater than the first threshold, the second condition that the number of color materials used in the engine unit 17 for copying is the second threshold or less, and the third condition that the level of easiness of reading of the printed sheet is equal to or greater than the third threshold using known teaming methods. Then, the determination unit 40C can calculate the recommended setting using the calculation formula.

Further, the determination unit 40C can compute and determine the recommended setting for copying based on the function selected by a user from the function of the engine unit 17, and the document information acquired by the acquisition unit 40A.

In this description, the determination unit 40C can acquire information indicating the function selected by the user from the operation panel 27 via the acquisition unit 40A and the reception unit 40B. For example, the determination unit 40C receives information indicating whether to use the bookbinding printing function as the information of the function of the engine unit 17 selected by the user. In this case, the display control unit 40D can display a selection screen for letting the user to select whether to use the bookbinding printing function of the engine unit 17 on the operation panel 27. The timing when the selection screen is displayed can be any timing before the determination unit 40C computes and determines the recommended setting.

For example, the display control unit 40D can be configured to display a button image used for setting whether to use the bookbinding printing function of the engine unit 17 within the initial screen 51 (see FIG. 4). Then, if the user operates the button image, the display control unit 40D displays a selection screen for letting the user to select whether to use the bookbinding printing function of the engine unit 17 on the operation panel 27. Then, if the user operates the selection screen and selects whether to use the bookbinding printing function or not, the reception unit 40B receives information indicating whether to use the bookbinding printing function or not and outputs the information to the acquisition unit 40A.

Then, the determination unit 40C receives the information indicating whether to use the bookbinding printing function as the information of the function selected by the user from the acquisition unit 40A.

In this example case, it is assumed that the function of the engine unit 17 includes the bookbinding printing function and the information of the function selected by the user is a use of “bookbinding printing function.” In this example case, the determination unit 40C computes and determines the recommended setting by reading the recommended setting corresponding to the function of the engine unit 17 (including the bookbinding printing function), specified by the function information acquired by the acquisition unit 40A, the document sheet number information included in the document information acquired by the acquisition unit 40A, and the document face information included in the document information acquired by the acquisition unit 40A, from the recommended setting management information 25A.

On the other hand, it can be assumed that the function of the engine unit 17 includes the bookbinding printing function, and the information of the function selected by the user is a no-use of “bookbinding printing function.” In this example case, the determination unit 40C computes and determines the recommended setting by reading the recommended setting corresponding to the function of the engine unit 17 (excluding the bookbinding printing function), specified by the function information acquired by the acquisition unit 40A, the document sheet number information included in the document information acquired by the acquisition unit 40A, and the document face information included in the document information acquired by the acquisition unit 40A, from the recommended setting management information 25A.

Then, the determination unit 40C computes and determines the sheet reduction ratio by dividing the expected sheet amount used for copying a document on media based on the recommended setting with another expected sheet amount used for copying the same document on media based on the initial settings associated to the same document.

For example, the determination unit 40C subtracts the number of sheets to be used for copying when the document is copied based on the recommended setting from the number of sheets to be used for copying when the document is copied based on the document sheet number information indicated in the document information to generate a subtraction result, and then divides the subtraction result with the number of sheets to be used for copying when the document is copied based on the document sheet number information indicated in the document information to compute and determine the sheet reduction ratio.

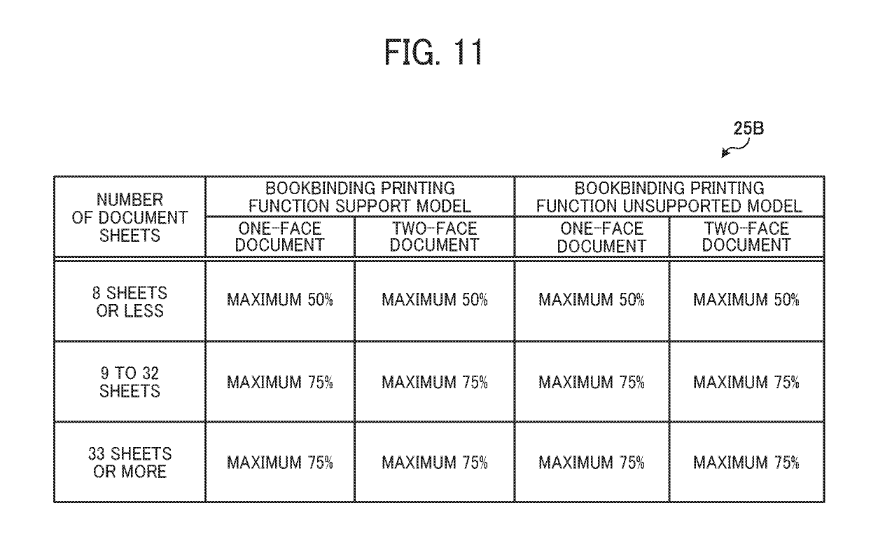

Further, the determination unit 40C can calculate the sheet reduction ratio using the resource reduction management information 25B. FIG. 11 illustrates an example of data configuration of the resource reduction management information 25B. The resource reduction management information 25B specifies the sheet reduction ratio corresponding to the recommended setting associated with the document face information and the document sheet number information set for each function of the engine unit 17 included in the recommended setting management information 25A (see FIG. 10). FIG. 11 illustrates an example case that the maximum sheet reduction ratio is specified.

In this example case, the determination unit 40C reads the sheet reduction ratio, corresponding to the function of the engine unit 17, the document sheet number information included in the document information, and the document face information included in the document information, acquired by the acquisition unit 40A, from the resource reduction management information 25B to compute and determine the sheet reduction ratio corresponding to the determined recommended setting (FIG. 10).

Further, the determination unit 40C can compute and determine the print-fee reduction ratio as a ratio of a first print fee when the document is copied on media in accordance with the document information and a second print fee when a document is copied on media based on the determined recommended setting, in which the determination unit 40C divides the second print fee when the document is copied on media based on the determined recommended setting with the first print fee when the document is copied on media in accordance with the document information to compute and determine the print-fee reduction ratio. The print-fee reduction ratio can be calculated variously as below

print-fee reduction ratio=second print fee (recommended setting)/first print fee (initial setting)

print-fee reduction ratio=[first print fee (initial setting)−second print fee (recommended setting)]/first print fee (initial setting)

In this case, for example, the determination unit 40C stores the print fee per sheet in the storage unit 25 in advance. Then, the determination unit 40C multiplies the number of sheets specified by the document sheet number information included in the document information and the print fee per sheet to calculate a multiplication result as the first print fee. Further, the determination unit 40C multiplies the number of sheets when the document is copied on media based on the determined recommended setting and the print fee per sheet to calculate a multiplication result as the second print fee. Then, the determination unit 40C subtracts the second print fee from the first print fee to obtain a subtraction result, and then divides the subtraction result with the first print fee to compute and determine the print-fee reduction ratio.

Referring back to FIG. 2, the description is continued. The display control unit 40D displays recommended information including the recommended setting and the sheet reduction ratio determined by the determination unit 40C on the operation panel 27. In the embodiment, the determination unit 40C displays a recommended information screen including the recommended information on the operation panel 27.

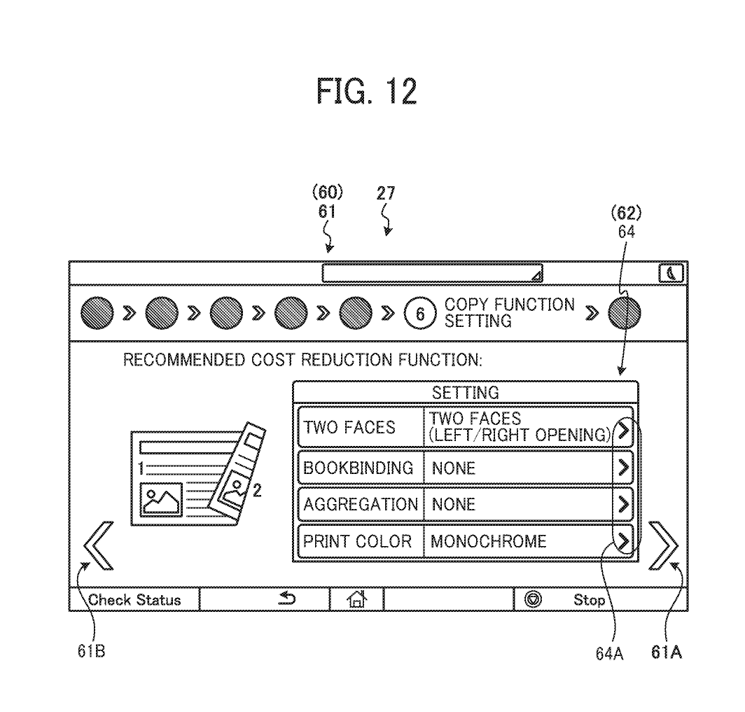

FIGS. 12 to 15 illustrate examples of schematic views of a recommended information screen 60,

For example, the display control unit 40D displays a recommended information screen 61 of FIG. 12 on the operation panel 27. Hereinafter, the recommended information screen 61 is described as one example of the recommended information screen 60. The recommended information screen 61 includes, for example, recommended setting 64, which is an example of information included in recommended information 62.

The recommended setting 64 displays a change button 64A used for changing each item included in the recommended setting 64, such as function, aggregation, and color material. By operating the change button 64A displayed on the operation panel 27, a user can change the content of each item included in the recommended setting 64,

Further, the recommended information screen 61 includes, for example, an icon 61A for receiving an instruction to execute the recommended setting 64 displayed on the recommended information screen 61, and an icon 61B for receiving an instruction to return to the previous screen.

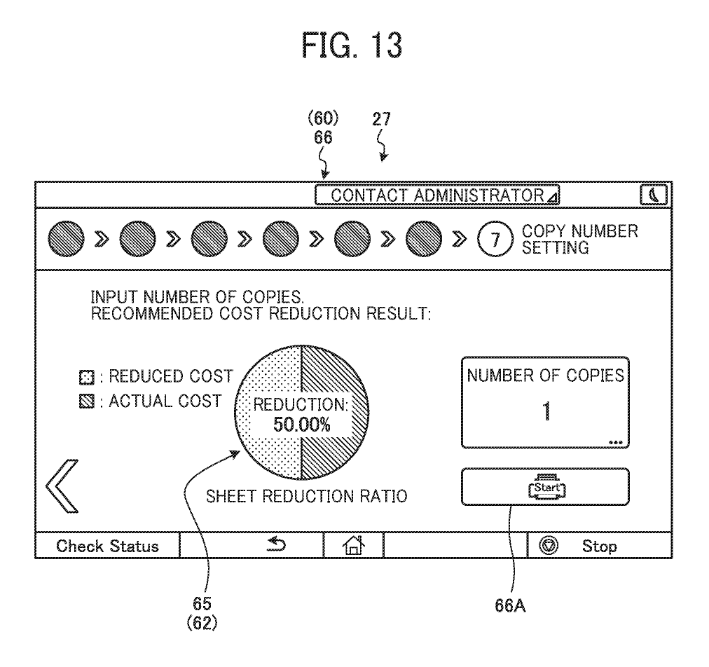

When the user operates the operation panel 27, the user checks the recommended setting 64 or changes the content of each item in the recommended setting 64, and then operates the icon 61A. When the display control unit 40D receives the execution instruction from the operation panel 27 via the reception unit 40B, the display control unit 40D displays the recommended information screen 60 including the sheet reduction ratio on the operation panel 27 as illustrated in FIG. 13.

FIG. 13 illustrates an example of a schematic view of a recommended information screen 66 including a sheet reduction ratio 65, which is an example of information included in the recommended information 62. Hereinafter, the recommended information screen 66 is described as one example of the recommended information screen 60. As illustrated in FIG. 13, the display control unit 40D can display a graphical image indicating the sheet reduction ratio 65 on the operation panel 27. The graphical image indicates an effect when copying is performed based on the recommended setting 64 compared with when copying is performed based on the document information using visualized representation or image.

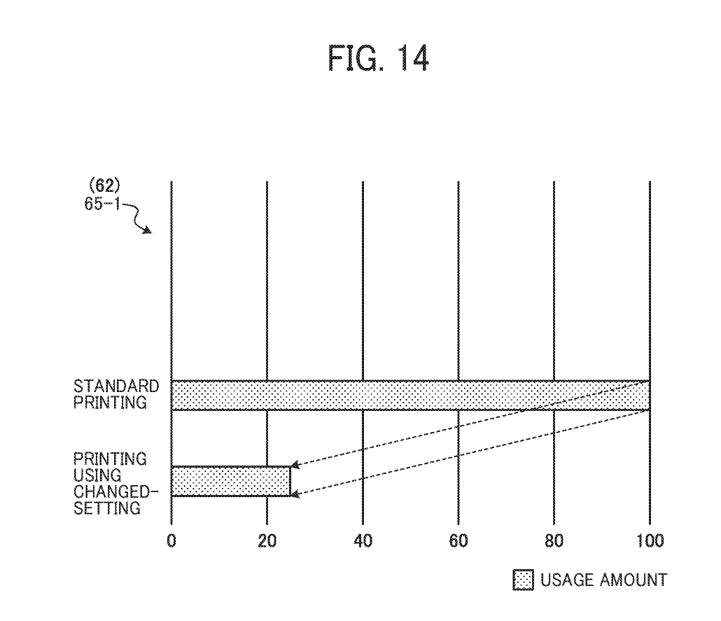

As illustrated in FIG. 13, the graphical image can be a pie chart, a bar graph or the like, but not limited thereto. For example, the graphical image indicating the sheet reduction ratio 65 can be set as a graphical image 65-1 represented by a bar graph as illustrated in FIG. 14. The graphical image 65-1 is an example of information included in the recommended information 62.

By displaying the graphical image indicating the sheet reduction ratio 65 on the operation panel 27, the display control unit 40D can provide information indicating the sheet reduction ratio 65 in a form intuitively comprehensible to a user. After inputting the number of copies of the target document to be printed on the operation panel 27, the user operates an icon 66A indicating a copy execution on the operation panel 27. Then, the reception unit 40B outputs a copy execution information indicating that the target document is to be copied based on the input number of copies and the recommended setting 64 to the print control unit 121 of the main unit 10 via the acquisition unit 40A. The copy execution information is one example of the execution information. The print control unit 121 controls the engine unit 17 in accordance with the received copy execution information to copy the document on one or more sheets based on the recommended setting 64 included in the copy execution information.

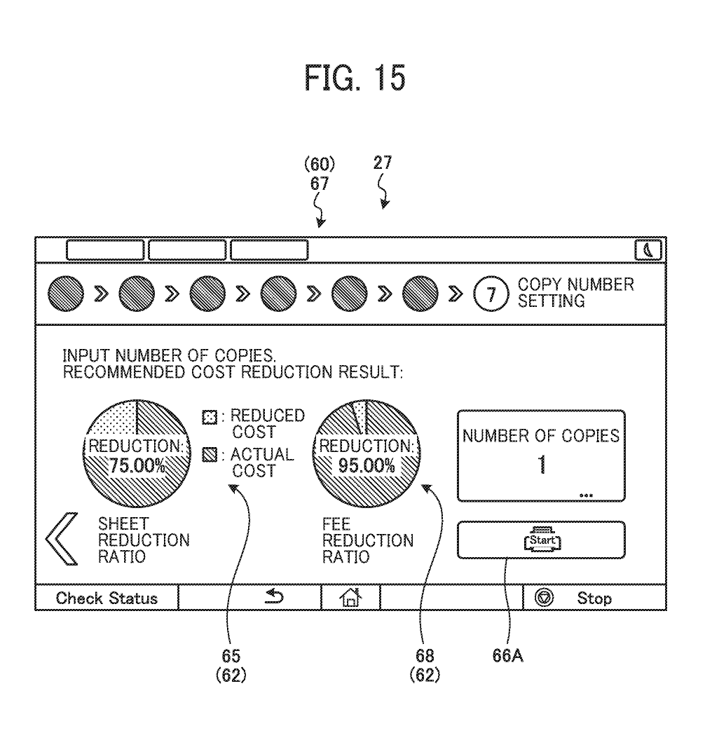

The display control unit 40D can further display the recommended information 62 including the print-fee reduction ratio on the operation panel 27 as illustrated in FIG. 15.

FIG. 15 illustrates an example of a schematic view of a recommended information screen 67 including the sheet reduction ratio 65 and a print-fee reduction ratio 68, which are examples of information included in the recommended information 62. Hereinafter, the recommended information screen 67 is described as one example of the recommended information screen 60. As illustrated in FIG. 15, the display control unit 40D can display the recommended information 62 including one graphical image indicating the sheet reduction ratio 65 and another graphical image indicating the print-fee reduction ratio 68 on the operation panel 27. The display control unit 40D can set the recommended setting 64 and the sheet reduction ratio 65 on the recommended information screen 60 to display the recommended setting 64 and the sheet reduction ratio 65 on the operation panel 27. Further, the display control unit 40D can set the recommended setting 64, the sheet reduction ratio 65, and the print-tee reduction ratio 68 on the recommended information screen 67 to display the recommended setting 64, the sheet reduction ratio 65, and the print-fee reduction ratio 68 on the operation panel 27.

As above described, the display control unit 40D can display the recommended information 62 including the recommended setting 64 and the sheet reduction ratio 65 on the operation panel 27.

As above described, the recommended setting 64 indicates conditions for copying that is recommended by the processing unit 40 in view of the function included in the engine unit 17, such as the duplex printing function, aggregation function, and bookbinding printing function. As described above, the recommended setting 64 includes the recommended setting associated with the sheet reduction ratio that is equal to or greater than the first threshold based on the document information and the function of the engine unit 17. Further, the sheet reduction ratio 65 indicates a reduction ratio of sheet amount, which is defined as a ratio of the expected sheet amount when the document is copied on media based on the recommended setting 64 and another expected sheet amount when the document is copied on media based on the initial settings included in the document information.

Therefore, the display control unit 40D can display the recommendation setting 64 corresponding to the function of the engine unit 17 and information indicating an effect of using the recommendation setting 64 on the operation panel 27.

Further, as described above, based on the document information and the function of the engine unit 17, the determination unit 40C can compute and determine the recommended setting 64 that satisfies at least any one of the first condition that the sheet reduction ratio is equal to or greater than the first threshold, the second condition that the number of color materials used in the engine unit 17 for copying is the second threshold or less, and the third condition that the level of easiness of reading of the printed sheet is equal to or greater than the third threshold. In this case, the display control unit 40D can display the recommended setting 64 in line with the sheet reduction ratio, the number of color materials, and the level of easiness of reading of the printed sheet and the information indicating the effect using the recommended setting 64 on the operation panel 27.

Hereinafter, a description is given of an example of information processing performed at the MFP 100.

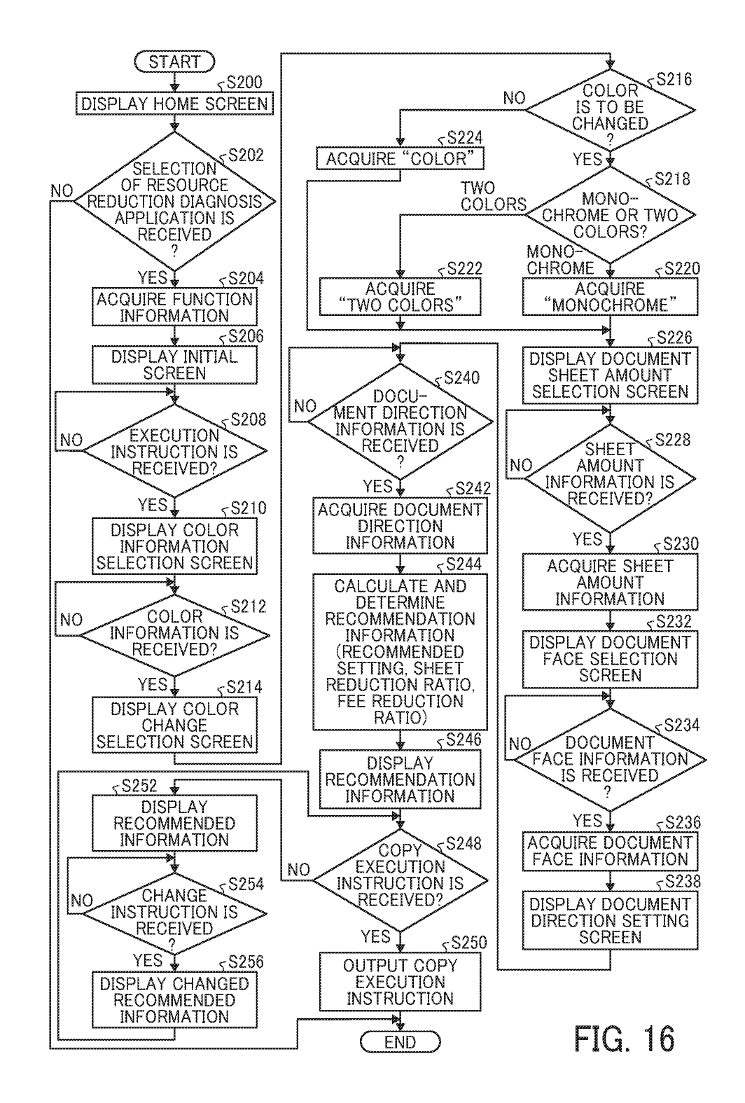

FIG. 16 is an example of a flowchart illustrating the steps of processing information at the MFP 100 of the embodiment.

When the power supply to the MFP 100 is turned ON, the display control unit 40D displays the home screen 50 (FIG. 3) on the operation panel 27 (step S200).

Then, the reception unit 40B determines whether a selection of the resource reduction diagnosis application is received (step S202). If the reception unit 40B determines that the selection of the resource reduction diagnosis application is not received (step S202: NO), the MFP 100 performs normal processing and ends the sequence. The normal processing is a process for controlling the engine unit 17 to execute a mechanism corresponding to an icon instructed by a user, which is selected from the icons indicating various applications displayed on the home screen 50.

On the other hand, if the reception unit 40B determines that the selection of the resource reduction diagnosis application is received (step S202: YES), the sequence proceeds to step S204. In step S204, the acquisition unit 40A acquires the function information of the engine unit 17 from the print control unit 121 of the main unit 10 (step S204).

Then, the display control unit 40D displays the initial screen 51 (FIG. 4) on the operation panel 27 (step S206).

Then, the reception unit 40B determines whether information indicating the execution instruction of the resource reduction diagnosis application is received (step S208). The reception unit 40B repeats step S208 if the reception unit 40B determines that the information indicating the execution instruction of the resource reduction diagnosis application is not yet received (step S208: NO). On the other hand, if the reception unit 40B determines that the information indicating the execution instruction of the resource reduction diagnosis application is received in step S208 (step S208: YES), the sequence proceeds to step S210. Further, if the reception unit 40B determines that the information indicating the execution instruction of the resource reduction diagnosis application is not received in step S208 (step S208: NO), the sequence can be ended.

In step S210, the display control unit 40D displays the color information selection screen 52 (FIG. 5) on the operation panel 27 (step S210).

Then, the reception unit 40B determines whether the color information is received (step S212). The reception unit 40B repeats step S212 if the reception unit 409 determines that the color information is not yet received in step S212 (step S212: NO). On the other hand, if the reception unit 40B determines that the color information is received in step S212 (step S212: YES), the sequence proceeds to step S214. Further, if the reception unit 409 determines that the color information is not received in step S212 (step S212: NO), the sequence can be ended.

In step S214, the display control unit 40D displays the color change selection screen 53 (FIG. 6) on the operation panel 27 (step S214).

Then, the reception unit 40B determines whether the color change information received from the operation panel 27 indicates “color is to be changed” (step S216). If the reception unit 40B determines that the color change information is “color is not to be changed” (step S216: NO), the sequence proceeds to step S224.

In step S224, the acquisition unit 40A acquires “color” as the color information (step S224). Then, the sequence proceeds to step S226, which will be described later.

On the other hand, if the reception unit 409 determines that the color change information received from the operation panel 27 is “color is to be changed” (step S216: YES), the sequence proceeds to step S218.

In step S218, the reception unit 40B determines whether the color change information received from the operation panel 27 indicates “monochrome” or “copy using two colors” (step S218).

If the reception unit 40B determines that the color change information indicates “monochrome” in step S218 (step S218: monochrome), the sequence proceeds to step S220. In step S220, the acquisition unit 40A acquires “monochrome” as the color information (step S220), and then the sequence proceeds to step S226, which will be described later.

On the other hand, if the reception unit 409 determines that the color change information indicates “copy using two colors” in step S218 (step S218: two colors), the sequence proceeds to step S222. In step S222, the acquisition unit 40A acquires “two colors” as the color information (step S222), and then the sequence proceeds to step S226, which will be described later.

In steps S212 to S224, the acquisition unit 40A acquires the color information related to the document face of the document to be copied.

Then, in step S226, the display control unit 40D displays the document sheet amount selection screen 54 (FIG. 7) on the operation panel 27 (step S226).

Then, the reception unit 40B determines whether the document sheet number information (sheet amount information of the document) is received (step S228). The reception unit 40B repeats step S228 if the reception unit 40B determines that the document sheet number information is not yet received (step S228: NO). On the other hand, if the reception unit 40B determines that the document sheet number information is received in step S228 (step S228: YES), the sequence proceeds to step S230. Further, if the reception unit 40B determines that the document sheet number information is not received in step S228 (step S228: NO), the sequence can be ended.

In step S230, the acquisition unit 40A acquires the document sheet number information of the document (sheet amount information of the document) received in step S228 (step S230).

Then, the display control unit 40D displays tine document face selection screen 55 (FIG. 8) on the operation panel 27 (step S232).

Then, the reception unit 40B determines whether the document face information is received (step S234). The reception unit 40B repeats step S234 if the reception unit 40B determines that the document face information is not yet received (step S234: NO). On the other hand, if the reception unit 40B determines that the document face information is received in step S234 (step S234: YES), the sequence proceeds to step S236. Further, if the reception unit 40B determines that the document face information is not received in step S234 (step S234: NO), the sequence can be ended.

In step S236, the acquisition unit 40A acquires the document face information received in step S234.

Then, the display control unit 40D displays the document direction setting screen 56 (FIG. 9) on the operation panel 27 (step S238).

Then, the reception unit 40B determines whether the document direction information is received (step S240). The reception unit 40B repeats step S240 if the reception unit 40B determines that the document direction information is not yet received (step S240: NO). On the other hand, if the reception unit 40B determines that the document direction information is received in step S240 (step S240: YES), the sequence proceeds to step S242. Further, if the reception unit 40B determines that the document direction information is not received in step S240 (step S240: NO), the sequence can be ended.

In step S242, the acquisition unit 40A acquires the document direction information received in step S240 (step S242).

In steps S206 to S242, the acquisition unit 40A acquires the document information as above described.

Then, the determination unit 40C computes and determines the recommendation information 62 based on the function information of the engine unit 17 acquired in step S204 and the document information acquired in steps S206 to S242 (step S244).

Then, the display control unit 40D displays the recommended information screen 60 (FIGS. 12 to 15) including the recommended information 62 on the operation panel 27 (step S246).

Then, the reception unit 40B determines whether a copy execution instruction is received from the operation panel 27 (step S248). If the reception unit 40B determines that the copy execution instruction is received in step S248 (step S248: YES), the acquisition unit 40A outputs the copy execution information for instructing an execution of copying the document on media based on the number of copies specified in the recommended setting 64 displayed on the recommended information screen 60, to the print control unit 121 (step S250). The print control unit 121 controls the engine unit 17 to perform copying the document on media based on the number of copies specified by the recommended setting 64 included in the received copy execution information. Then, the sequence is ended or terminated.

On the other hand, if the reception unit 40B determines that the copy execution instruction is not received in step S248 (step S248: NO), the sequence proceeds to step S252.

In step S252, the display control unit 40D displays the recommended information screen 60 (FIGS. 12 to 15) including the recommended information 62, calculated and determined in step S244, on the operation panel 27 (step S252).

Then, the reception unit 40B determines whether a change instruction of each item included in the recommendation information 62 is received (step S254). The reception unit 40B repeats step S254 if the reception unit 40B determines that the change instruction of each item included in the recommendation information 62 is not yet received (step S254: NO). On the other hand, if the reception unit 40B determines that the change instruction of each item included in the recommendation information 62 is received in step S254 (S254: YES), the sequence proceeds to step S256.

In step S256, the display control unit 40D displays the recommended information screen 60 including the recommended information 62 changed in step S254 on the operation panel 27 (step S256). Then, the sequence returns to step S248.

As described above, the MFP 100 (information processing apparatus) includes the acquisition unit 40A, the determination unit 40C, and the display control unit 40D. The acquisition unit 40A acquires the document information associated with the document. The determination unit 40C computes and determines, based on the document information and the function of the engine unit 17 (execution unit) used for copying or printing the document on media, the recommended setting used for printing, and the reduction ratio of the used media amount when printing is performed based on the recommended setting. The display control unit 40D displays the recommended information 62 including the recommended setting and the reduction ratio of the used media amount on the operation panel 27 (display unit).

As above described, the MFP 100 displays the recommended information 62 including the recommended setting and the reduction ratio of resource, which are determined based on the document information and the function of the engine unit 17, on the operation panel 27.

Therefore, the MFP 100 (information processing apparatus) can provide the information including the recommended setting and the effect of using the recommended setting in accordance with the function of the engine unit 17 (execution unit) that executes the printing.

In the embodiment, a method of processing information can be devised. The method of processing information includes, for example, acquiring document information associated with a document, determining, based on the document information and a function of the engine unit 17 (execution unit) that prints the document on a medium, recommended setting for printing and a reduction ratio of resource for printing by calculating a ratio of an amount of the resource required for printing when the printing is performed based on the acquired document information and an amount of the resource required for printing when the printing is performed based on the recommended setting, and displaying recommended information 62 including the recommended setting and the reduction ratio of the resource on the operation panel 27 (display unit).

In the embodiment, a non-transitory computer readable storage medium storing one or more instructions that, when executed by one or more processors, cause the one or more processors to execute a method of processing information is devised. The method of processing information includes, for example, acquiring document information associated with a document, determining, based on the document information and a function of the engine unit 17 (execution unit) that prints the document on a medium, recommended setting for printing and a reduction ratio of resource for printing by calculating a ratio of an amount of the resource required for printing when the printing is performed based on the acquired document information and an amount of the resource required for printing when the printing is performed based on the recommended setting, and displaying recommended information 62 including the recommended setting and the reduction ratio of the resource on the operation panel 27 (display unit).

The function of the engine unit 17 includes one or more functions related to printing a document on media, but not limited thereto. Further, the function of the engine unit 17 includes, for example, at least one of the duplex printing function for printing document faces of a document on two faces of each medium, the aggregation function for aggregating a plurality of document faces on one face of each medium, and the bookbinding printing function for sorting and printing document faces of a document on media to create a half fold book, but not limited thereto.

The document information includes, for example, the document sheet number information indicating the number of document sheets to be copied or printed, and the document face information indicating whether the document face of document to be copied or printed is the one-face document or two-face document, but not limited thereto.

The reception unit 40B receives the information and instruction input by a user. The acquisition unit 40A acquires the document information from the reception unit 40B.

The display control unit 40D displays the reception screen 58 including the selection area 54C including the plurality of selectable options corresponded to different sheet number ranges, which are set in accordance with the number of document sheets (document sheet number information) suitable for the bookbinding printing on the operation panel 27 (display unit). The acquisition unit 40A acquires the document information including the document sheet number information indicating the sheet number range input via the selection area 54C from the reception unit 40B.

The determination unit 40C computes and determines the recommended setting associated with the sheet reduction ratio that is equal to or greater than the first threshold based on the document information and the function of the engine unit 17 (execution unit).

Further, based on the document information and the function of the engine unit 17, the determination unit 40C can compute and determine the recommended setting that satisfies at least any one of the first condition that the sheet reduction ratio is equal to or greater than the first threshold, the second condition that the number of color materials used by the engine unit 17 (execution unit) for copying is the second threshold or less, and the third condition that the level of easiness of reading of the printed sheet is equal to or greater than the third threshold.

The determination unit 40C further computes and determines the print-fee reduction ratio by dividing the second print fee when a document is copied on media based on the determined recommended setting with the first print fee when the document is copied on media in accordance with the document information of the target document. The display control unit 40D displays the recommended information 62 including the recommended setting, the reduction ratio of resource, such as the sheet reduction ratio and/or the print-fee reduction ratio on the operation panel 27 (display unit).

The display control unit 40D displays the graphical image indicating the reduction ratio of resource on the operation panel 27 (display unit).

One or more programs executable in the MFP 100 of the embodiment can be installed on the ROM or the like in advance and provided. Further, the programs executable in the MFP 100 of the embodiment may be recorded on a computer-readable recording medium such as a compact disc read only memory (CD-ROM), a flexible disk (FD), a compact disc recordable (CD-R), a digital versatile disk (DVD), a secure digital (SD) memory card, or the like in a file of an installable format or an executable format.

Further, the programs executable in the MFP 100 of the embodiment can be stored on a computer connected to a network such as the Internet, and downloaded via the network for providing the programs. Alternatively, the programs executable in the MFP 100 of the embodiment may be provided or distributed via a network such as the Internet.

The programs executable in the MFP 100 of the embodiment can be used for implementing a module configuration including each of the above described units (e.g., acquisition unit 40A, reception unit 40B, determination unit 40C, display control unit 40D, print control unit 121), and when the CPU (e.g., processor) reads the programs from the ROM and executes the programs, each of the above described units is loaded on a main storage device and generated on the main storage device used in the actual hardware configuration. Further, for example, some or all of the above described functional units can be implemented using one or more dedicated hardware circuits.

Although the MFP 100 is exemplified as the information processing apparatus of the embodiment as above described, the above described embodiment can be applied any apparatus or system including a printing mechanism, other than the MFP 100.

Typically, an execution unit for executing the printing operation may include different functions depending on configurations designed for image forming apparatuses. However, conventional techniques cannot provide the recommended setting in accordance with the function of the execution unit and information indicating an effect of using the recommended setting.

As to the above described embodiment, the information processing apparatus, the method of processing information, and the storage medium can provide the recommended setting in accordance with the function of the execution unit for executing the printing and the information indicating the effect of using the recommended setting,

Numerous additional modifications and variations are possible in light of the above teachings. It is therefore to be understood that, within the scope of the appended claims, the disclosure of this patent specification can be practiced otherwise than as specifically described herein. Any one of the above-described operations may be performed in various other ways, for example, in an order different from the one described above.

Each of the functions of the above-described embodiments can be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), system on a chip (SOC), graphics processing unit (GPU), and conventional circuit components arranged to perform the recited functions.

What is claimed is:

1. An information processing apparatus comprising:
circuitry configured to
acquire document information associated with a document;
determine recommended setting for printing and a reduction ratio of resource for printing based on the document information and a function of an execution device that prints image of the document on a medium, the reduction ratio of resource being calculated based on a ratio of an amount of the resource required for printing when the printing is performed based on the acquired document information and an amount of the resource required for printing when the printing is performed based on the recommended setting; and
display recommended information including the recommended setting and the reduction ratio of the resource on a display.

2. The information processing apparatus of claim 1,
wherein when the resource is the number of sheets required for printing, the circuitry calculates the reduction ratio of the resource as a sheet reduction ratio.

3. The information processing apparatus of claim 2,
wherein the function of the execution device includes a function related to printing the document on the medium.

4. The information processing apparatus of claim 3,
wherein the function of the execution device includes at least one of a duplex printing function for printing a document face of the document on two faces of the medium, an aggregation function for aggregating a plurality of document faces of the document on a face of the medium, and a bookbinding printing function for sorting and printing a plurality of document faces of the document to create a half fold book.

5. The information processing apparatus of claim 1,
wherein the document information includes document sheet numb information indicating the number of sheets of the document to be printed, and document face information indicating whether the document to be printed is a one-face document having an image on one face of one document sheet or a two-face document having an image on both faces of one document sheet.

6. The information processing apparatus of claim 5, further comprising an operation device, wherein the circuitry acquires the document information from the operation device in response to an input of the document information at the operation device.

7. The information processing apparatus of claim 6,
wherein the circuitry displays a screen including a plurality of selectable options on the display, each selectable option set with different sheet number ranges in accordance with the number of sheets of the document suitable for the bookbinding printing,
wherein the circuitry acquires the document information including the document sheet number information indicating any one of the sheet number ranges input via any one of the selectable options displayed on the display.

8. The information processing apparatus of claim 7,
wherein the document information further includes color information of the document face of the document.

9. The information processing apparatus of claim 2,
wherein the circuitry determines the recommended setting enabling the sheet reduction ratio being equal to or greater than a first threshold based on the document information and the function of the execution device.

10. The information processing apparatus of claim 9,
wherein the circuitry determines the recommended setting that satisfies any one of a first condition that the sheet reduction ratio is equal to or greater than the first threshold, a second condition that the number of color materials used by the execution device for printing is equal to or less than a second threshold, a third condition that a level of easiness of reading of printed sheet is equal to or greater than a third threshold, a combination of any two of the first, second and third conditions, and a combination of the first, second and third conditions.

11. The information processing apparatus of claim 2,
wherein when the resource required for printing is a print fee, the circuitry further calculates a print-fee reduction ratio as the reduction ratio of the resource by dividing a second print fee required for printing when the document is printed on the medium based on the recommended setting with a first print fee required for printing when the document is printed on the medium based on the document information associated with the document, and the circuitry displays the recommended information including the recommended setting and the reduction ratio of the resource including the sheet reduction ratio and the print-fee reduction ratio on the display

12. The information processing apparatus of claim 1, wherein the circuitry displays a graphical image indicating the reduction ratio of the resource on the display.

13. A method of processing information comprising:
acquiring document information associated with a document;
determining, based on the document information and a function of an execution device that prints the document on a medium, recommended setting for printing and a reduction ratio of resource for printing by calculating a ratio of an amount of the resource required for priming when the printing is performed based on the acquired document information and an amount of the resource required for printing when the printing is performed based on the recommended setting; and
displaying recommended information including the recommended setting and the reduction ratio of the resource on a display.

14. A non-transitory computer readable storage medium storing one or more instructions that, when executed by one or more processors, cause the one or more processors to execute a method of processing information, the method comprising:
acquiring document information associated with a document;
determining, based on the document information and a function of an execution device that prints the document on a medium, recommended setting for printing and a reduction ratio of resource for printing by calculating a ratio of an amount of the resource required for printing when the printing is performed based on the acquired document information and an amount of the resource required for printing when the printing is performed based on the recommended setting; and
displaying recommended information including the recommended setting and the reduction ratio of the resource on a display.
